(19) United States
(12) Patent Application Publication
(10) Pub. No.: US 2011/0234147 A1
(43) Pub. Date: Sep. 29, 2011

(54) CONTROLLER FOR SPINDLE WITH ENCODER

(75) Inventors: Yasusuke IWASHITA, Minamitsuru-gun (JP); Tadashi Okita, Minamitsuru-gun (JP); Takahiro Akiyama, Minamitsuru-gun (JP); Geng Li, Minamitsuru-gun (JP)

(73) Assignee: FANUC CORPORATION, Minamitsuru-gun (JP)

(21) Appl. No.: 13/035,648

(22) Filed: Feb. 25, 2011

(30) Foreign Application Priority Data
Mar. 29, 2010 (JP) 2010-074221

(51) Int. Cl. H02P 23/00

(52) U.S. Cl. 318/799

(57) ABSTRACT

A controller controls the rotational speed of an induction motor, thereby controlling a spindle connected to the induction motor. Although an encoder for detecting the position of the spindle is mounted on the spindle, a speed detector is not attached to the induction motor. The speed of the induction motor is estimated from a spindle speed obtained by the encoder, and an excitation frequency command for the induction motor is determined based on the estimated speed.

### BACKGROUND OF THE INVENTION

1. Field of the Invention

The present invention relates to a controller configured so that an induction motor is connected to the spindle of a machine tool or the like through a reduction mechanism, including a belt, gears, etc., and the spindle is controlled by controlling the rotational speed of the induction motor, and more particularly, to a spindle controller configured so that the spindle fitted with an encoder for detecting the position of the spindle is controlled without a speed detector attached to the induction motor.

2. Description of the Related Art

There is an induction motor (i.e., sensorless induction motor) that is not provided with a sensor, such as a speed detector, in order to reduce the cost of the motor. In the control of the sensorless induction motor, the motor speed is estimated within software based on an actual current flowing through the motor. This estimated speed is used in calculating a torque command and determining the phases of currents passed through the windings of the motor. This control is the so-called vector control that is frequently used, as disclosed in Japanese Patent Application Laid-Open No. 2002-51594.

FIG. 6 is a schematic diagram illustrating a spindle to which a sensorless induction motor is applied. The spindle of FIG. 6 is applied to, e.g., a lathe. An induction motor (sensorless induction motor) 2 without a sensor for detecting the motor speed transmits its driving force to a spindle 6 of the lathe or the like through a reduction mechanism 4 including a belt 5 and gears (not shown). The spindle 6 is fitted with an encoder 8, which outputs feedback pulses Pfb for detecting the rotational position of the spindle. The feedback pulses Pfb output from the encoder 8 on the spindle 6 are used to control the rotational position of the spindle and achieve functions, such as a spindle position stopping function.

In a subtracter 10, a speed deviation is obtained by subtracting an estimated speed value ωrest of the sensorless induction motor 2 estimated by a speed estimator 15 from a speed command ωrcmd output from a host controller (not shown). A speed control unit 11 obtains a current command by performing proportional-plus-integral (PI) control or the like of the speed deviation. A current control unit 12 obtains a voltage command based on the current command and an actual current Ire flowing through the induction motor 2 detected by a current detector 14. The obtained voltage command is output to a power amplifier unit 13. The speed estimator 15 estimates the rotational speed of the induction motor 2 from the actual current Ire flowing through the motor 2 detected by the current detector 14 and calculates the estimated speed value ωrest. Since the calculation of the rotational speed of the motor by the speed estimator 15 based on the actual current Ire is performed by a conventional method, a detailed description of this method is omitted.

FIG. 7 is a schematic block diagram illustrating a motor control unit of FIG. 6. The motor control unit performs vector control in which an IQ command (IQcmd) as a torque command and an ID command (IDcmd) as an excitation command are independently controlled. As described with reference to FIG. 6, the induction motor 2 is connected to the spindle 6 through the reduction mechanism 4, and the spindle 6 is fitted with the encoder 8 for detecting the rotational position of the spindle. The encoder 8 outputs the feedback pulses Pfb as the spindle 6 rotates. A three-phase to two-phase converter 27 acquires a three-phase current feedback of a drive current supplied from the power amplifier unit 13 to the induction motor 2, and converts the three-phase current feedback pulse to a two-phase current feedback pulse (DQ conversion), thereby obtaining current feedbacks IQ and ID.

A subtracter 20 obtains the speed deviation by subtracting the estimated speed value ωrest from the speed command ωrcmd output from the host controller (not shown). In a speed compensator 21, a current command (torque command IQcmd) is obtained by subjecting the obtained speed deviation to proportional-plus-integral (PI) control or the like. In a subtracter 22, a current deviation is obtained by subtracting a Q-phase current feedback IQ from the torque current command IQcmd, and the obtained current deviation is output to an excitation frequency command calculation unit 23. Here “est” of ωrest is an abbreviation of estimation.

The excitation frequency command calculation unit 23 obtains a first excitation frequency command ω1* based on the current deviation. Since the calculation of the first excitation frequency command ω1* based on the current deviation is performed by a conventional method, a detailed description of this method is omitted. An integrator 24 calculates an excitation phase θ by integrating the first excitation frequency command ω1*.

A slip estimation unit 28 calculates an estimated slip value ωsest based on the Q- and D-phase current feedbacks IQ and ID and outputs the result to a subtracter 30. In the slip estimation unit 28, the slip value can be estimated according to a calculation formula, ωsest=K×IQ/ID, where K is a constant. The subtracter 30 obtains the estimated speed value ωrest by subtracting the estimated slip value ωsest from the first excitation frequency command ω1*. The obtained estimated speed value ωrest is output to a primary excitation frequency command computation unit 29 as well as to the subtracter 20.

The primary excitation frequency command computation unit 29 calculates an ID command (IDcmd) as an excitation command, based on the estimated speed value ωrest calculated by the subtracter 30. A subtracter 31 subtracts the D-phase current feedback ID from the excitation command (IDcmd) and outputs the result of the subtraction to a voltage command calculation unit 32. The voltage command calculation unit 32 calculates voltage commands VD and VQ, based on the IQ command (IQcmd) as the torque command, the ID command (IDcmd) as the excitation command, the D-phase current feedback ID, the Q-phase current feedback IQ, and the first excitation frequency command ω1*. Since the voltage commands VD and VQ are calculated by a conventional method, a detailed description of this method is omitted.

The two-phase to three-phase converter 25 executes conversion (reverse DQ conversion) from two-phase voltage commands to three-phase voltage commands based on the phase θ for the voltage commands VD and VQ output from the voltage command calculation unit 32 and outputs a three-phase voltage command (PWM) to the power amplifier.

Various methods are proposed for the control of a sensorless induction motor. In one such control method, the motor speed is estimated from a current feedback. As described above in connection with the prior art, the speed control is performed based on the speed command ωrcmd and the estimated speed value ωrest. In the case of the induction motor where voltage saturation is promoted when the rotation is speeded up, the excitation current needs to be reduced for high-speed drive. If this is done, however, the estimated slip value, and hence, the estimated speed value ωrest and the excitation frequency command ω1* inevitably differ from their true values, so that the induction motor fails to produce desired output power. Thus, the prior art motor control method has a problem that the output is reduced to such a level that desired cutting cannot be achieved if an estimated error of the motor speed is substantial.

### SUMMARY OF THE INVENTION

Accordingly, in consideration of the above-described problems of the prior art, the object of the present invention is to provide a controller for a spindle with an encoder, capable of detecting the speed of the spindle by means of the encoder on the spindle and obtaining the clamp value of the excitation frequency of an induction motor based on motor speed information estimated from the detected spindle speed, thereby preventing a reduction in output attributable to an excessive error of the excitation frequency.

The present invention provides a controller configured to control a rotational speed of an induction motor, thereby controlling a spindle connected to the induction motor. The spindle is fitted with an encoder for detecting a position of the spindle. The controller comprises a spindle speed detection unit which detects a speed of the spindle from the number of feedback pulses of the encoder within a predetermined period of time, a motor speed estimation unit which obtains an estimated speed of the induction motor from the spindle speed detected by the spindle speed detection unit and a reduction ratio between the spindle and the induction motor, and an excitation frequency command determination unit which determines an excitation frequency command for the induction motor based on the estimated speed obtained by the motor speed estimation unit.

The controller may further comprise an excitation frequency command calculation unit which calculates a first excitation frequency command based on a speed command for the induction motor and a motor current flowing through the induction motor, a storage unit in which maximum slip frequency data corresponding to the estimated speed obtained by the motor speed estimation unit is stored, and an excitation frequency command limit value calculation unit which calculates a limit value of the excitation frequency command calculated by the excitation frequency command calculation unit based on the estimated speed and the maximum slip frequency data. The excitation frequency command determination unit determines an excitation frequency command for the induction motor based on the first excitation frequency command calculated by the excitation frequency command calculation unit and the excitation frequency command limit value calculated by the excitation frequency command limit value calculation unit.

According to the present invention, there may be provided a controller for a spindle with an encoder, capable of detecting the speed of the spindle by means of the encoder on the spindle and obtaining the clamp value of the excitation frequency of an induction motor based on obtained motor speed information, thereby preventing a reduction in output attributable to an excessive error of the excitation frequency.

### BRIEF DESCRIPTION OF THE DRAWINGS

The above and other objects and features of the present invention will be obvious from the ensuing description of embodiments with reference to the accompanying drawings, in which:

FIG. 1 is a schematic block diagram illustrating a spindle to which is applied a sensorless induction motor in which feedback pulses from an encoder are also used to determine an excitation frequency command in current control;

FIG. 2 is a schematic block diagram illustrating the spindle to which is applied the sensorless induction motor in which the feedback pulses from the encoder are also used in current control, and illustrates a control block for a controller according to the present invention;

FIG. 3 is a flowchart showing an algorithm of processing for sensorless control of the sensorless induction motor;

FIG. 4 is a diagram illustrating how the maximum output characteristics of the induction motor are improved by limiting the excitation frequency command by means of the controller according to the present invention;

FIG. 5 is a graph for comparing the respective maximum motor outputs of the present invention and the prior art, and shows that the maximum output of the induction motor, at a predetermined or higher rotational frequency, can be improved by the control of the present invention compared with conventional control;

FIG. 6 is a diagram illustrating a lathe spindle to which a sensorless induction motor is applied; and

FIG. 7 is a diagram illustrating a conventional sensorless control block.

### DETAILED DESCRIPTION OF THE PREFERRED EMBODIMENTS

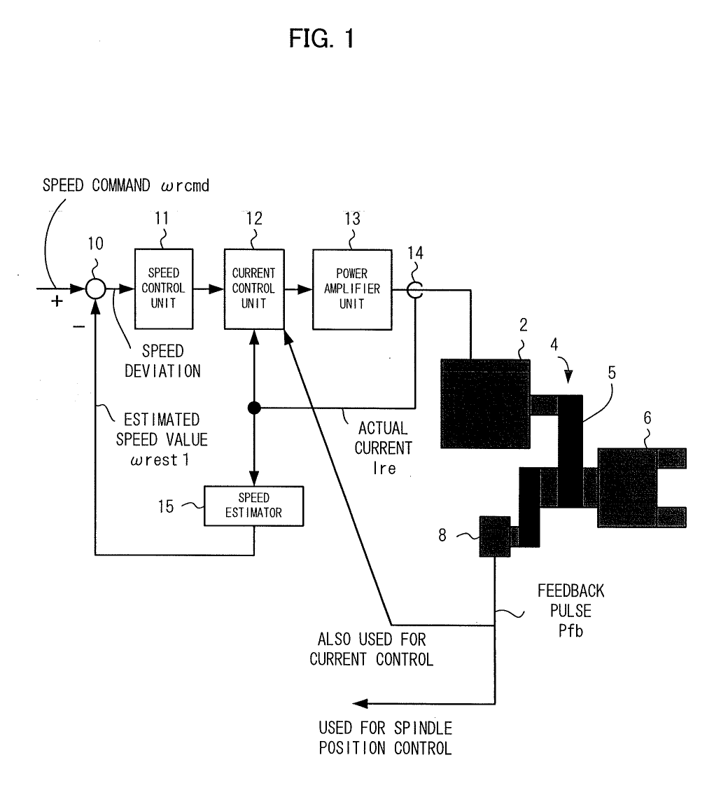

FIG. 1 is a schematic block diagram illustrating a spindle to which is applied a sensorless induction motor in which feedback pulses from an encoder are also used to determine an excitation frequency command in current control.

An induction motor (sensorless induction motor) 2 without a motor speed sensor transmits its driving force to a spindle 6 of a lathe or the like through a reduction mechanism 4 including a belt 5 and gears (not shown). The spindle 6 is fitted with an encoder 8, which outputs feedback pulses Pfb for detecting the rotational position of the spindle. The feedback pulses Pfb output from the encoder 8 on the spindle 6 are used to control the rotational position of the spindle and achieve functions, such as a spindle position stopping function.

In a subtracter 10, a speed deviation is obtained by subtracting a first estimated speed value ωrest1 of the sensorless induction motor 2 estimated by a speed estimator 15 from a speed command ωrcmd output from a host controller. A speed control unit 11 obtains a current command by performing proportional-plus-integral (PI) control or the like of the speed deviation. A current control unit 12 obtains a voltage command based on the current command and an actual current Ire flowing through the induction motor 2 detected by a current detector 14. The obtained voltage command is output to a power amplifier unit 13 comprising an inverter.

The speed estimator 15 estimates the rotational speed of the induction motor 2 from the actual current Ire flowing through the induction motor 2 detected by the current detector 14 and calculates the first estimated speed value ωrest1. Since the calculation of the rotational speed of the motor by the speed estimator 15 based on the actual current Ire is performed by a conventional method, a detailed description of this method is omitted.

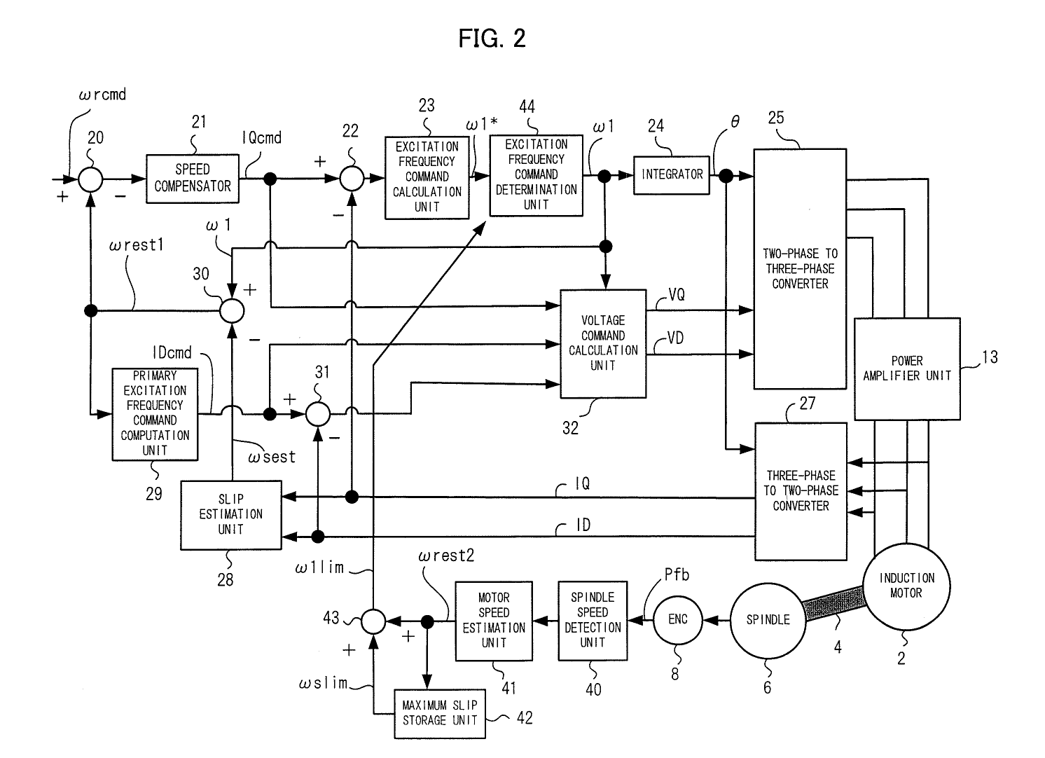

FIG. 2 is a schematic block diagram illustrating the spindle to which is applied the sensorless induction motor in which the feedback pulses from the encoder are also used in current control, and illustrates a control block for a controller according to the present invention. This control block shows vector control in which an IQ command (IQcmd) as a torque command and an ID command (IDcmd) as an excitation command are independently controlled.

In a subtracter 20, the speed deviation is obtained by subtracting the first estimated speed value ωrest1 from the speed command ωrcmd. A speed compensator 21 obtains a torque current command IQcmd by performing the PI control or the like with respect to the speed deviation. In a subtracter 22, a current deviation is obtained by subtracting a Q-phase current feedback IQ from the torque current command IQcmd. An excitation frequency command calculation unit 23 obtains an excitation frequency command ω1* based on the current deviation.

An excitation frequency command determination unit 44 compares the excitation frequency command ω1* obtained by the excitation frequency command calculation unit 23 with an excitation frequency command limit value ω1lim, and acquires an excitation frequency command ω1 by limiting the maximum value of the excitation frequency command ω1* to the excitation frequency command limit value ω1lim. The acquired excitation frequency command ω1 is output to a subtracter 30 and a voltage command calculation unit 32. The excitation frequency command limit value ω1lim is calculated by an excitation frequency command limit value calculation unit 43.

An integrator 24 calculates an excitation phase θ by integrating the excitation frequency command ω1 output from the excitation frequency command determination unit 44. The excitation phase θ calculated by the integrator 24 is output to a two-phase to three-phase converter 25 and a three-phase to two-phase converter 27.

Two-phase voltage commands VQ and VD from the voltage command calculation unit 32 are input to the two-phase to three-phase converter 25. In the two-phase to three-phase converter 25, the two-phase voltage commands VQ and VD are converted to three-phase voltage commands, which are output to the power amplifier unit 13. A three-phase drive current is output from the power amplifier unit 13 to the induction motor 2. The drive current supplied from the power amplifier unit 13 to the induction motor 2 is detected by means of a current detection element (current detector 14 of FIG. 1), as shown in FIG. 1, and detected data is output to the three-phase to two-phase converter 27.

As described with reference to FIG. 1, the induction motor 2 is connected to the spindle 6 through the reduction mechanism 4, and the spindle 6 is fitted with the encoder 8 for detecting the rotational position of the spindle. The encoder 8 outputs the feedback pulses Pfb as the spindle 6 rotate. The feedback pulses Pfb output from the encoder 8 are input to a spindle speed detection unit 40. In the spindle speed detection unit 40, an encoder speed (spindle speed) is calculated based on the count value of the feedback pulses Pfb for each control period. Since the encoder 8 is mounted on the spindle 6, its speed represents the spindle speed.

The spindle speed obtained by the spindle speed detection unit 40 is input to a motor speed estimation unit 41. In the motor speed estimation unit 41, a second estimated speed value ωrest2, an estimated speed of the induction motor 2, is calculated from the spindle speed calculated in the spindle speed detection unit 40 according to the following equation (1), based on the gear ratio of the reduction mechanism 4. Since the resolution of the encoder 8 for spindle position detection is generally coarse, the motor speed estimation unit 41 may use a value obtained by filtering its feedback data.

ωrest2=Encoder speed(spindle speed)×(Reduction ratio between spindle and induction motor). (1)

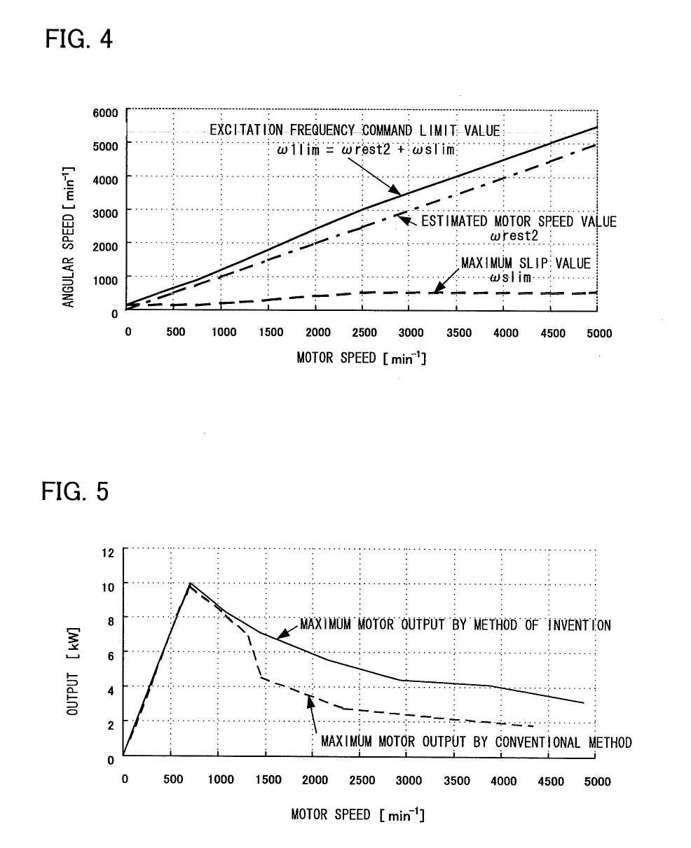

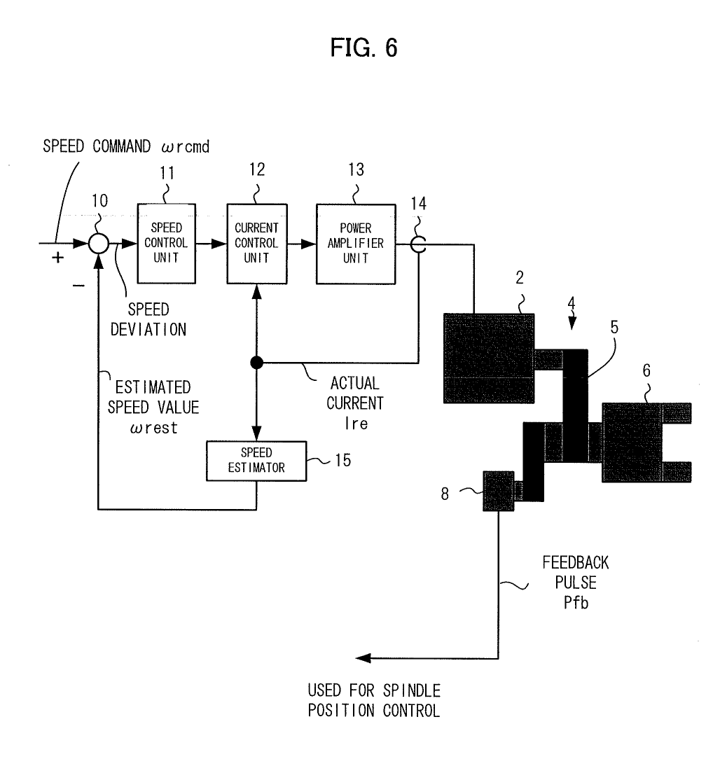

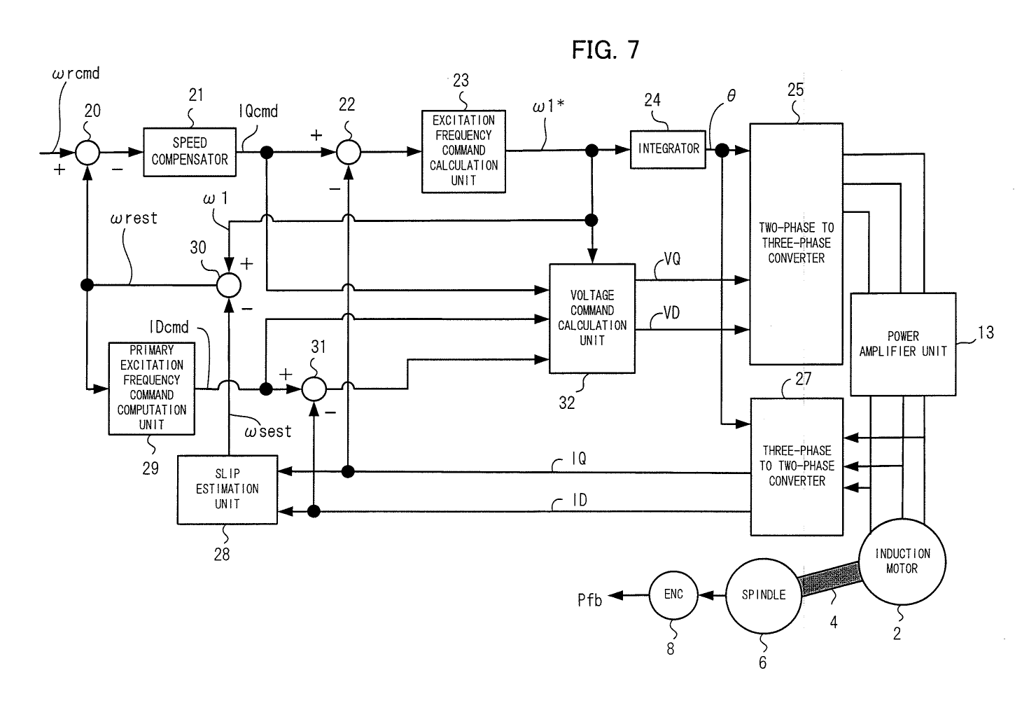

A table representing the relationship between the second estimated speed value ωrest2 and an ideal slip maximum slip storage unit 42 is stored in a maximum slip storage unit 42. The maximum slip storage unit 42 is provided with a table, such as the one shown in FIG. 4, representative of the relationship between the slip value and a motor speed obtained when the induction motor is ideally driven. A maximum slip value ωslim at a certain speed is defined with reference to the table based on the second estimated speed value ωrest2. The slip can be obtained from, for example, the motor constant and speed.

The maximum slip value ωslim, which is an ideal slip value corresponding to the second estimated speed value ωrest2 input from the motor speed estimation unit 41, is output from the maximum slip storage unit 42 to the excitation frequency command limit value calculation unit 43. The excitation frequency command limit value calculation unit 43 calculates the excitation frequency command limit value ω1lim as a maximum excitation frequency command according to the following equation (2), and outputs a calculated value to the excitation frequency command determination unit 44.

ω1lim=ωrest2+ωslim. (2)

The three-phase to two-phase converter 27 acquires a three-phase current feedback of the drive current supplied from the power amplifier unit 13 to the induction motor 2, and converts the three-phase current feedback to a two-phase current feedback based on the phase obtained by the integrator 24 (DQ conversion), thereby obtaining current feedbacks IQ and ID.

A slip estimation unit 28 calculates an estimated slip value ωsest based on the Q- and D-phase current feedbacks IQ and ID from the three-phase to two-phase converter 27. In the slip estimation unit 28, the slip value can be estimated according to a calculation formula, ωsest=K×IQ/ID, where K is a constant. The slip estimation unit 28 outputs the calculated estimated slip value ωsest to the subtracter 30. The subtracter 30 obtains the first estimated speed value ωrest1 by subtracting the estimated slip value ωsest from the excitation frequency command ω1 from the excitation frequency command determination unit 44. The subtracter 30 outputs the calculated first estimated speed value ωrest1 to the subtracter 20 and a primary excitation frequency command computation unit 29.

The primary excitation frequency command computation unit 29 calculates an ID command (IDcmd) as an excitation command, based on the first estimated speed value ωrest1 from the subtracter 30. A subtracter 31 subtracts the current feedback ID from the ID command and outputs the result of the subtraction (deviation) to the voltage command calculation unit 32.

The voltage command calculation unit 32 calculates the voltage commands VD and VQ, based on the IQ command (IQcmd) as the torque command, the ID command (IDcmd) as the excitation command, the Q-phase current feedback IQ, and the excitation frequency command ω1. Since the voltage commands VD and VQ are calculated by a conventional method, a detailed description of this method is omitted.

The two-phase to three-phase converter 25 executes conversion (reverse DQ conversion) from two-phase voltage commands to three-phase voltage commands based on the phase θ for the voltage commands VD and VQ and outputs a three-phase voltage command (PWM) to the amplifier.

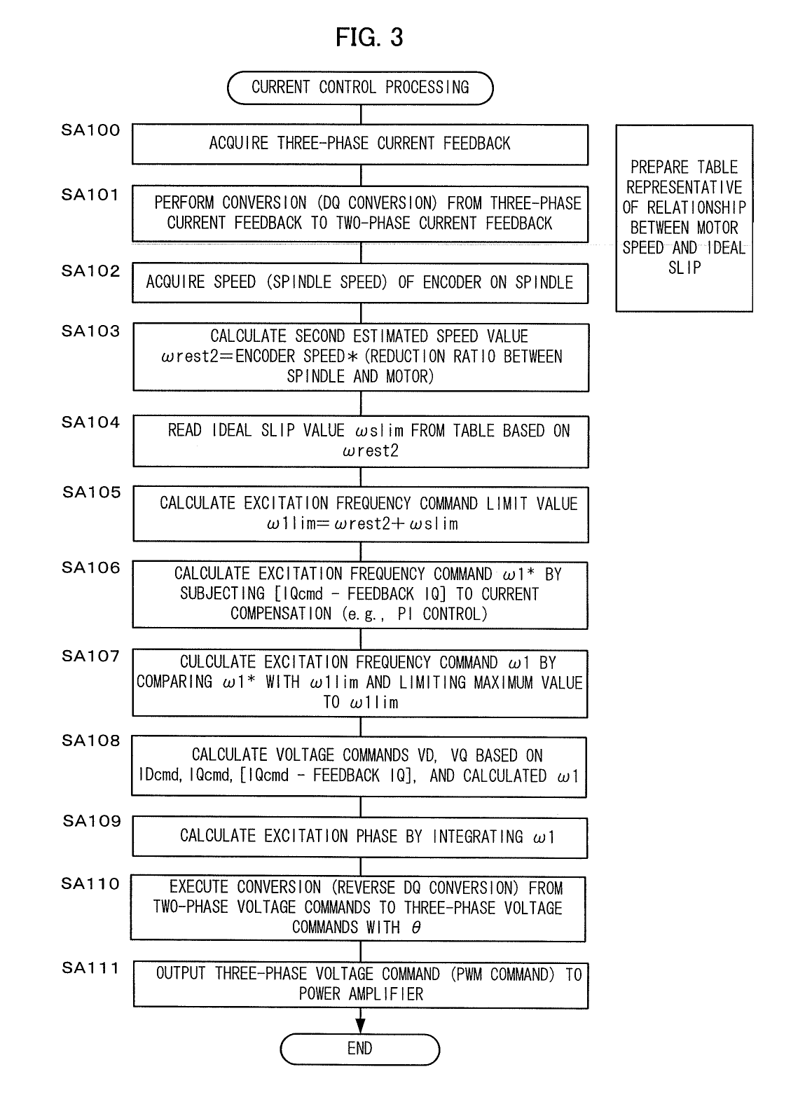

FIG. 3 is a flowchart showing an algorithm of processing for sensorless control of the sensorless induction motor. The following is a description of steps of this processing.

[Step SA100] The three-phase current feedback is acquired.

[Step SA101] The three-phase current feedback is converted to the two-phase current feedbacks IQ and ID (DQ conversion).

[Step SA102] The detected value (encoder speed=spindle speed) of the encoder mounted on the spindle is acquired.

[Step SA103] The second estimated speed value ωrest2 of the induction motor is calculated according to the following equation, based on the encoder speed acquired in Step SA102.

ωrest2=Encoder speed×(Reduction ratio between spindle and induction motor).

[Step SA104] The maximum slip value ωslim as the ideal slip value is read from the table in the maximum slip storage unit, based on the second estimated speed value ωrest2 calculated in Step SA103.

[Step SA105] The excitation frequency command limit value ω1lim is calculated according to the following equation, based on the maximum slip value ωslim read in Step SA104 and the second estimated speed value ωrest2 of the induction motor calculated in Step SA103.

ω1lim=ωrest2+ωslim.

[Step SA106] The excitation frequency command ω1* is calculated by subjecting the deviation (IQcmd−Q-phase current feedback IQ) between the IQ command (IQcmd) and the Q-phase current feedback IQ to current compensation (e.g., PI control).

[Step SA107] The excitation frequency command ω1 is acquired by comparing the excitation frequency command ω1* calculated in Step SA106 with the excitation frequency command limit value whim calculated in Step SA105 and limiting the maximum value of the excitation frequency command ω1* to the excitation frequency command limit value ω1lim.

[Step SA108] The voltage commands VD and VQ are calculated based on the IQ command (IQcmd), ID command (IDcmd), (IDcmd−D-phase current feedback ID), and excitation frequency command ω1 acquired in Step SA107.

[Step SA109] The excitation phase θ is obtained by integrating the excitation frequency command ω1 acquired in Step SA107.

[Step SA110] The conversion (reverse DQ conversion) from two-phase voltage commands to three-phase voltage commands is executed based on the excitation phase θ obtained in Step S107.

[Step SA111] The three-phase voltage command (PWM) obtained in Step SA110 is output to the amplifier, whereupon the processing terminates.

FIG. 4 is a diagram illustrating how the maximum output characteristics of the induction motor are improved by limiting the excitation frequency command according to the present invention. The maximum output characteristics of the induction motor 2 can be improved by adding the maximum slip value ωslim to the second estimated speed value ωrest2 of the induction motor 2 and carrying out excitation with the excitation frequency command limit value ω1lim. FIG. 5 is a graph for comparing the respective maximum motor outputs of the present invention and the prior art. FIG. 5 shows that the maximum output of the induction motor, at a predetermined or higher rotational frequency, can be improved by the control of the present invention compared with conventional control.

In general, an encoder is mounted on the spindle of a lathe or the like and it is used to control the position of the spindle. Since this encoder is mounted on the spindle, the connection between the spindle and the induction motor is not close (or there is backlash or slippage between them), and the resolution of feedback signals is coarse. In some cases, therefore, it is difficult to use the encoder directly for speed control of the induction motor.

According to the present invention, however, a reduction in output attributable to an excessive error of the excitation frequency can be prevented by obtaining the clamp value of the excitation frequency command ω1, based on the induction motor speed obtained from the feedback value of a current for driving the induction motor.

What is claimed is:

1. A controller configured to control a rotational speed of an induction motor, thereby controlling a spindle connected to the induction motor, the spindle being fitted with an encoder for detecting a position of the spindle, the controller comprising:
a spindle speed detection unit which detects a speed of the spindle from the number of feedback pulses of the encoder within a predetermined period of time;
a motor speed estimation unit which obtains an estimated speed of the induction motor from the spindle speed detected by the spindle speed detection unit and a reduction ratio between the spindle and the induction motor; and
an excitation frequency command determination unit which determines an excitation frequency command for the induction motor based on the estimated speed obtained by the motor speed estimation unit.

2. The controller according to claim 1, further comprising:
an excitation frequency command calculation unit which calculates a first excitation frequency command based on a speed command for the induction motor and a motor current flowing through the induction motor;
a storage unit in which maximum slip frequency data corresponding to the estimated speed obtained by the motor speed estimation unit is stored; and
an excitation frequency command limit value calculation unit which calculates a limit value of the excitation frequency command calculated by the excitation frequency command calculation unit based on the estimated speed and the maximum slip frequency data,
wherein the excitation frequency command determination unit determines an excitation frequency command for the induction motor based on the first excitation frequency command calculated by the excitation frequency command calculation unit and the excitation frequency command limit value calculated by the excitation frequency command limit value calculation unit.
